(19) United States
(12) Patent Application Publication
(10) Pub. No.: US 2010/0054837 A1
(43) Pub. Date: Mar. 4, 2010

(54) Thermal printer

(76) Inventor: Hideki SAKAI, Chiba-shi (JP)

Correspondence Address: BRUCE L. ADAMS, ESQ, ADAMS & WILKS, 17 BATTERY PALCE - SUITE 1231, NEW YORK, NY, 10004, US

(21) Appl. No.: 12/583,736

(22) Filed: Aug. 25, 2009

(30) Foreign Application Priority Data
Aug. 25, 2008 (JP) 2008-215120

(51) Int. Cl. B41J 15/00

(52) U.S. Cl. 400/613

(57) ABSTRACT

In order to provide a thermal printer capable of restraining automatically-continued rotation of roll paper after stop of rotation of a platen roller without damaging the roll paper, and of smoothly performing an initial operation of the roll paper, the thermal printer is characterized in that a roll paper holding mechanism (20) comprises: a shaft (52) inserted into a hollow (10) of roll paper (P) to support the roll paper (P); and a holder (51) including supporting portions (55) and (56) for supporting poles (61) of the shaft (52), and in that the roll paper (P) is supported rotatably with respect to the shaft (52), whereas the shaft (52) is supported unrotatably with respect to the holder (51).

### BACKGROUND OF THE INVENTION

1. Field of the Invention

The present invention relates to a thermal printer in which various types of information are printed on a recording sheet pulled out of roll paper.

2. Description of the Related Art

Thermal printers of various types are provided at present in which printing is performed by pressing a heated thermal head against a special recording sheet which undergoes a color change when heat is applied thereto. In particular, the thermal printer is preferably used in printing variety of labels, receipts, and tickets because it is possible to perform the printing of smooth letters and various graphics without using toners, inks, or the like.

The thermal printer generally includes a holder in which the recording sheet is placed, the above-mentioned thermal head including a large number of heat-generating elements, a platen roller which pinches the recording sheet against the thermal head, and a motor for rotating the platen roller through a gear to feed the recording sheet. The recording sheet used for the thermal printer is normally used in a state of being wound around a cylindrical core tube into roll paper.

For placing the roll paper in the holder, a shaft is first inserted through the core tube. Thereafter, the shaft is held by the holder. Then, for feeding the recording sheet at the time of printing, the motor is first driven to rotate the platen roller. As a result, the recording sheet is pulled by the rotation of the platen roller to rotate the shaft and the roll paper, thereby continuously pulling out the recording sheet toward the thermal head.

With the increased performance of the thermal head or the like, the recent thermal printers is capable of performing high-speed printing on the recording sheet.

In order to perform the high-speed printing on the recording sheet, however, it is necessary to increase the speed of feeding the recording sheet. Therefore, the roll paper must be rotated at high speed. In this case, there is a problem that the roll paper automatically continues rotating after the stop of the rotation of the platen roller to loosen the recording sheet between the platen roller and the holder. As a result, when the printing is subsequently performed, there arises inconvenience such as the misalignment of the recording sheet fed to the thermal head with respect to a conveying direction, resulting in a paper jam or lowered printing precision.

In order to cope with this problem, for example, patent document JP 2001-302031 A discloses a structure including a rotation restraining portion provided immediately below the roll paper to be allowed to abut against an outer circumference of the roll paper, which increases a load to the rotational movement of the roll paper by the contact between the rotation restraining portion and the roll paper when the paper feeding is stopped.

In the structure disclosed in patent document JP 2001-302031 A described above, however, the rotation restraining portion is brought into contact with the outer circumferential surface of the roll paper to reduce the rotation of the roll paper by friction between the roll paper and the rotation restraining portion. Therefore, there is a fear that the roll paper is damaged by the friction. For example, when the print surface side of the roll paper and the rotation restraining portion are brought into contact with each other, the print surface sometimes changes in color by frictional heat. Therefore, there is a problem that the printing precision is lowered.

In addition, in the conventional thermal printers, when the recording sheet is intended to be fed from the large-diameter roll paper having a large outer diameter size (for example, about six inches), the roll paper is too heavy to be rotated. As a result, the recording sheet cannot be fed in some cases. If the roll paper does not rotate, there is a fear that a load is applied to the motor for driving the platen roller to cause step-out of the motor. In order to cope with this, the recording sheet can be easily fed even from the large-diameter roll paper by increasing the size of the motor for rotating the platen roller. However, the increase in size of the motor brings about an increase in apparatus size and an increase in manufacturing cost.

### SUMMARY OF THE INVENTION

The present invention has been devised in view of the circumstances described above, and provides a thermal printer capable of restraining automatically-continued rotation of roll paper after stop of rotation of a platen roller without damaging the roll paper, and of smoothly performing an initial operation of the roll paper.

In order to solve the above-mentioned problems, the present invention provides the following means.

According to the present invention, a thermal printer includes: a roll paper holding mechanism for holding roll paper formed by winding a recording sheet to have a hollow therein; a thermal head including a large number of heat-generating elements arranged along a width direction of the recording sheet; and a platen roller for making a rotation while pinching the recording sheet against the thermal head to feed the recording sheet, performs printing on the recording sheet pulled out from the roll paper with the thermal head, and is wherein: the roll paper holding mechanism includes: a shaft inserted through the hollow to support the roll paper; and a holder including supporting portions for supporting both end portions of the shaft; and the roll paper is supported rotatably with respect to the shaft, whereas the shaft is supported unrotatably with respect to the holder.

According to the structure described above, immediately after the operation of the thermal printer is stopped, a force acts between the shaft and the holder in a direction against a rotating direction of the roll paper because the shaft is configured to be unrotatable with respect to the holder. In this case, the force acting against the rotating direction of the roll paper becomes greater as compared with the case where the shaft and the roll paper rotate in cooperation. Thus, a turning force of the roll paper can be actively attenuated.

As a result, after the stop of the rotation of the platen roller, the roll paper also quickly stops rotating. Thus, the recording sheet between the platen roller and the holder can be prevented from being loosened to prevent the occurrence of inconvenience such as the misalignment of the recording sheet fed to the thermal head with respect to the conveying direction. In particular, the rotation of the roll paper can be stopped without damaging the roll paper in comparison with a structure in which a rotation restraining portion is brought into contact with an outer circumferential surface of the roll paper as in the conventional cases, and hence printing precision on the recording sheet can be prevented from being lowered. As a result, the printing can be performed with high precision.

Further, the thermal printer according to the present invention is wherein an uneven portion is formed on an outer circumferential surface of the shaft.

According to the structure described above, the uneven portion is formed on the outer circumferential surface of the shaft. Therefore, when a contact portion of an inner circumferential surface of the hollow of the roll paper with the shaft passes from the concave portion through the convex portion or from the convex portion through the concave portion of the shaft at the time of the rotation of the roll paper with respect to the shaft, the turning force of the roll paper can be efficiently attenuated by a frictional force between a boundary portion of the uneven portion and the inner circumferential surface of the roll paper. As a result, after the stop of the rotation of the platen roller, the roll paper can also quickly stop rotating.

Further, the thermal printer according to the present invention is wherein a tension roller for biasing the recording sheet to apply a tension to the recording sheet is provided between the roll paper holding mechanism and the platen roller in a conveying direction of the recording sheet.

According to the structure described above, the tension roller is provided between the roll paper holding mechanism and the platen roller. As a result, the tension applied to the recording sheet can be adjusted between the roll paper holding mechanism and the platen roller. More specifically, at the time of an initial operation of the roll paper, if the platen roller is intended to be rotated while the roll paper is in a stationary state, the tension applied to the recording sheet bridged between the roll paper and the platen roller increases while the roll paper remains unrotated. As a result, the conveyance of the recording sheet is started while the tension roller is being moved against the biasing force of the tension roller. Thereafter, the roll paper starts rotating with respect to the shaft along with an inertia force of the recording sheet which has started to be conveyed. Therefore, as compared with the case where the roll paper is rotated simultaneously with the start of conveyance of the recording sheet, the roll paper can be easily rotated. As a result, the recording sheet can be smoothly guided to the thermal head. Therefore, the initial operation of the roll paper can be smoothly performed without increasing the size of a motor, and hence manufacturing cost can be reduced while an apparatus can be reduced in size.

Further, the thermal printer according to the present invention is wherein each of the both end portions of the shaft is formed to have an approximately square profile on a cross section vertical to an axial direction of the shaft.

According to the structure described above, the profile of the cross section of each of the both end portions of the shaft, which is vertical to the axial direction, is formed to have a square shape. As a result, it is possible to make the shaft unrotatable with respect to the holder.

Further, the thermal printer according to the present invention is wherein: each of the supporting portions is formed to have a V-groove shape to support at least two sides of each of the both end portions of the shaft; and the both end portions of the shaft are supported by the supporting portions to allow a diagonal of the cross section vertical to the axial direction to be aligned with a vertical direction.

According to the structure described above, the profile of the cross section of each of the both end portions of the shaft, which is vertical to the axial direction, is formed to have the square shape, while each of the supporting portions is formed to have the V-shape. As a result, for placing the roll paper, the supporting portion and the two sides of each of the both end portions of the shaft are held in an abutting states. As a result, the prevention of rotation of the shaft is ensured.

Moreover, the both end portions of the shaft are held in the supporting portions to allow the diagonal of the cross section of each of the both end portions of the shaft to be aligned with the vertical direction. As a result, even if one side of each of the both end portions abuts against the holding portion while being aligned with a horizontal direction when the shaft is to be placed in the holder, corners of each of the both end portions of the shaft slip down over the holding portion without getting stuck while slipping due to a load of the roll paper and the shaft. As a result, it is ensured that two sides of each of the both end portions abut against the holding portion. Therefore, the roll paper can be easily and surely placed.

According to the thermal printer of the present invention, the shaft is configured to be unrotatable with respect to the holder immediately after the operation of the thermal printer is stopped. Therefore, the force acts between the shaft and the holder in the direction against the rotating direction of the roll paper. In this case, the force acting against the rotating direction of the roll paper becomes greater as compared with the case where the shaft and the roll paper rotate in cooperation. As a result, the turning force of the roll paper can be actively attenuated.

As a result, after the stop of the rotation of the platen roller, the roll paper also quickly stops rotating. Thus, the recording sheet between the platen roller and the holder can be prevented from being loosened to prevent the occurrence of inconvenience such as the misalignment of the recording sheet fed to the thermal head with respect to the conveying direction. In particular, the rotation of the roll paper can be stopped without damaging the roll paper in comparison with a structure in which a rotation restraining portion is brought into contact with an outer circumferential surface of the roll paper as in the conventional cases, and hence printing precision on the recording sheet can be prevented from being lowered. As a result, the printing can be performed with high precision.

### BRIEF DESCRIPTION OF THE DRAWINGS

In the accompanying drawings:

FIG. 1 is a perspective view of a thermal printer according to an embodiment of the present invention;

FIG. 2 is a view from an arrow A of FIG. 1;

FIG. 3 is a partially cutaway sectional view of a print unit according to the embodiment of the present invention;

FIG. 4 is an enlarged perspective view of a roll paper holding mechanism according to the embodiment of the present invention; and

FIG. 5 is a perspective view of a shaft according to the embodiment of the present invention.

### DETAILED DESCRIPTION OF THE PREFERED EMBODIMENT

(Thermal Printer)

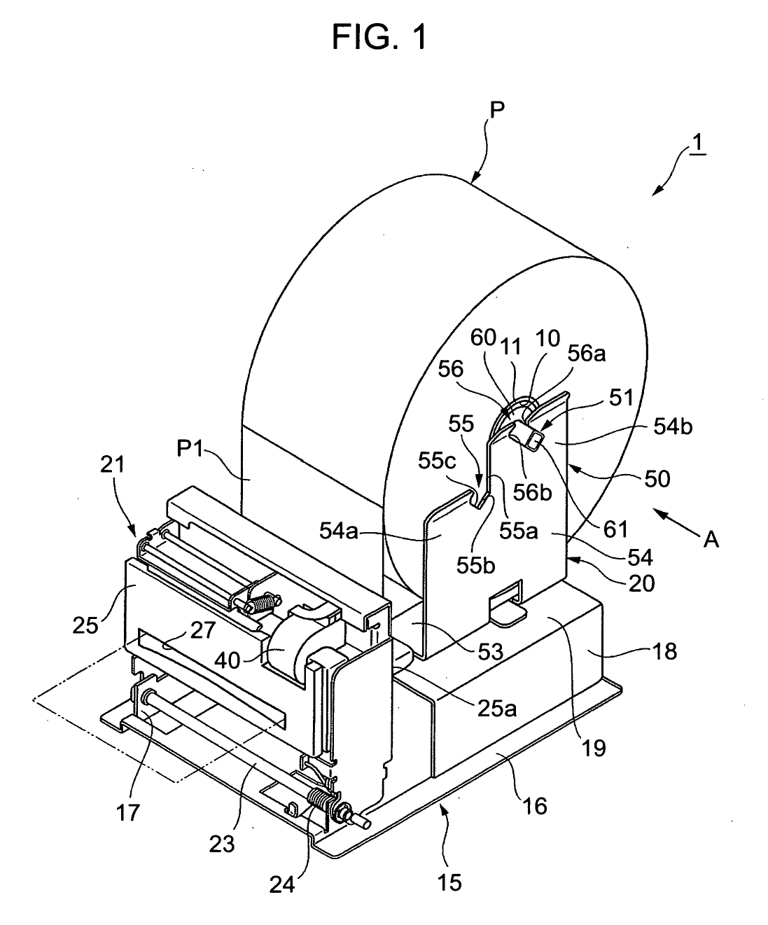

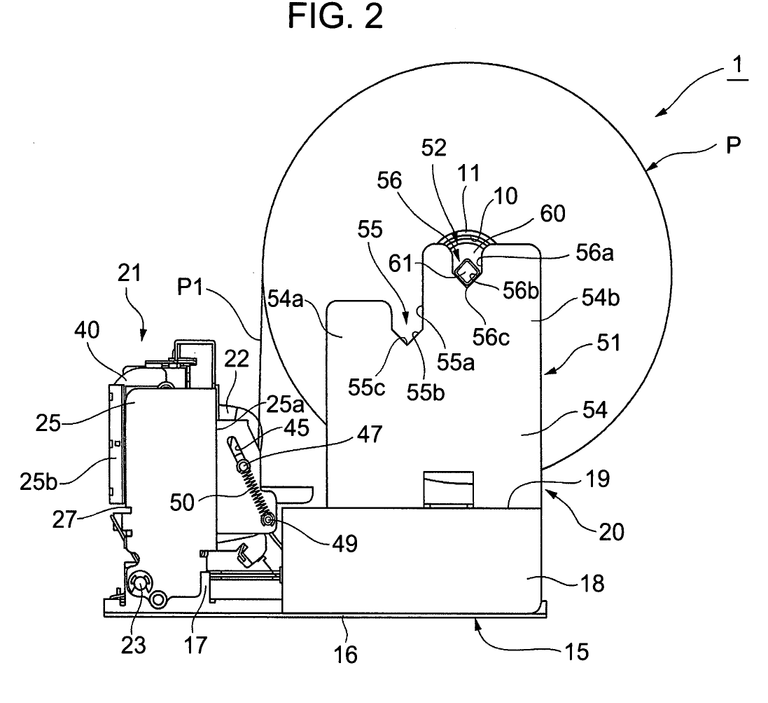

Next, an embodiment of the present invention is described based on FIGS. 1 to 5. FIG. 1 is a perspective view of a thermal printer. FIG. 2 is a view from an arrow A of FIG. 1. Note that, in FIGS. 1 to 5, illustrations thereof are abbreviated by appropriate omission of apart of the components, simplification of the configurations, and the like for facilitating the understanding of the invention.

As illustrated in FIGS. 1 and 2, in a thermal printer 1 according to this embodiment, roll paper P formed by winding a recording sheet P1 around a cylindrical core tube 11 having a hollow 10 therein is placed. Then, the thermal printer 1 performs printing on the recording sheet P1 pulled out from the roll paper P. As the roll paper P of this embodiment, the roll paper P having an outer diameter size of six inches is used.

The thermal printer 1 is used while incorporated, for example, in an account machine installed in a parking area or in an oil feeder in a self-service gas station, in ticket-vending machines installed in various restaurants, or in automatic teller machine (ATM) installed in a bank, and is provided in a case (not shown) of the account machine, the ticket-vending machine, or the ATM. Then, the recording sheet P1 printed by the thermal printer 1 is discharged through a discharge port (not shown) formed in the case, thereby being received by a user.

The thermal printer 1 includes a base 15 mounted in a casing (not shown), and a roll paper holding mechanism 20 and a print unit 21 which are provided on the base 15.

The base 15 is made of a metal material such as stainless steel, and includes a bottom panel 16, protruding portions 17 formed by bringing upright both sides of the bottom panel 16 on its one longitudinal end side (on the left side of FIG. 2) in a height direction of the bottom panel 16 (in a thickness direction of the bottom panel 16), side panels 18 extending from both sides of the bottom panel 16 on its other longitudinal end side in the height direction of the bottom panel 16, and an upper panel 19 formed to be bridged between the side panels 18.

On the upper panel 19, the roll paper holding mechanism 20 for holding the roll paper P is provided. The recording sheet 21 is fed from the roll paper holding mechanism 20 toward the print unit 21 to allow the print unit 21 to perform printing on the recording sheet P1. The roll paper holding mechanism 20 is described in detail below.

A turning shaft 23 is supported by the protruding portions 17 to be bridged between the protruding portions 17. The print unit 21 is turnably supported through the turning shaft 23. An elastic member 24 such as a torsion spring is provided to the turning shaft 23. One end side of the elastic member 24 abuts against an upper surface of the bottom panel 16, whereas the other end thereof abuts against the print unit 21. As a result, the print unit 21 is biased in a clockwise direction. A turnable lever (see FIG. 2) 22 is provided on one side wall of a casing 25 of the print unit 21 in a longitudinal direction (in a distant direction on the paper surface of FIG. 2). The lever 22 is locked to a hook (not shown) which is formed on one of the side panels 18 (on the distant side of the paper surface of FIG. 2). Then, the lever 22 is turned to cancel the locking state between the lever 22 and the hook, thereby allowing the print unit 21 to turn in a counterclockwise direction. For example, by turning the print unit 21 in the counterclockwise direction for replacing the paper or the like, a distance between the roll paper holding mechanism 20 and the print unit 21 is increased. As a result, a placement operation for placing the roll paper P or a pull-out operation for pulling the recording sheet P1 from the placed roll paper P to the print unit 21 can be easily performed.

(Print Unit)

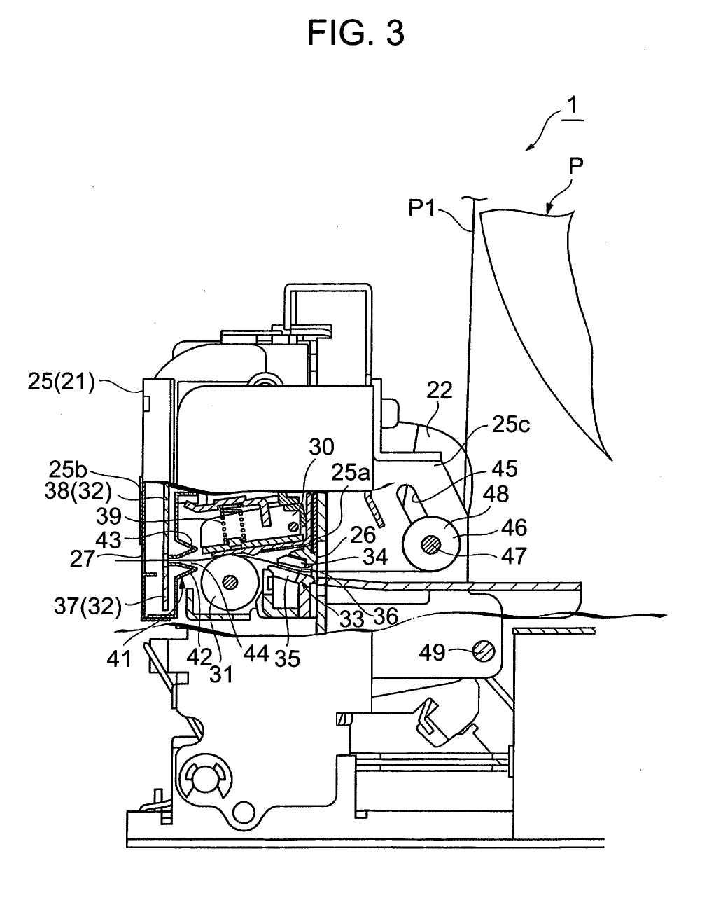

FIG. 3 is a partially cutaway sectional view of the print unit. As illustrated in FIGS. 1 to 3, a thermal head 30, a platen roller 31, and a cutting member 32 are provided in the casing 25 of the print unit 21. The casing 25 has a rectangular parallelepiped shape, and includes an entrance port 26 formed through a rear wall 25a in a width direction of the casing (through an end surface on the upstream side in a conveying direction of the recording sheet P1), through which, the recording sheet P1 pulled out from the roll paper P is conveyed, and a discharge port 27 provided through a front wall 25b (through an end surface on the downstream side in the conveying direction of the recording sheet P1) to be opposed to the entrance port 26, from which the recording sheet P1 subjected to the printing in the print unit 21 is discharged. Each of the entrance port 26 and the discharge port 27 is a slit-like opening formed in a lower part of the casing 25 along the longitudinal direction of the casing 25. The thermal head 30, the platen roller 31, and the cutting member 32 are placed between the entrance port 26 and the discharge port 27.

A first guide member 33 for guiding the recording sheet P1 into the print unit 21 is provided to an inner circumferential edge of the entrance port 26. The first guide member 33 includes an upper guide 34 provided to an upper inner circumferential edge of the entrance port 26 and a lower guide 35 provided to a lower inner circumferential edge thereof. A path between the guides 34 and 35 serves as a guide path 36 through which the recording sheet P1 is conveyed. A proximal end of each of the guides 34 and 35 is provided to cover the inner circumferential edge of the entrance port 26. An opposed surface of each of the guides is chamfered in an arc-like shape. Each of the guides 34 and 35 extends toward the interior of the print unit 21 (thermal head 30) in an upwardly inclined manner from the proximal end to the top.

The thermal head 30 having an approximately rectangular cross section is provided above the upper guide 34 to be adjacent to the upper guide 34 of the first guide member 33, and is placed so that its longitudinal direction is aligned with a width direction of the recording sheet Pl. The thermal head 30 performs the printing on the recording sheet P1 conveyed into the print unit 21, and includes a large number of heat-generating elements along the width direction of the recording sheet P1. Each of the heat-generating elements is controlled to generate heat based on a signal from a control section (not shown). By controlling the heat generation of the heat-generating elements, various types of characters, graphics and the like can be printed on a print surface of the recording sheet P1 (upper surface of the recording sheet P1 illustrated in FIG. 3). The thermal head 30 is in a biased state toward the platen roller 31 by an elastic member 39 such as a coil spring.

The platen roller 31 is disposed to be opposite to the thermal head 30 in the state of pinching therebetween the recording sheet P1 guided by the first guide member 33 so that an outer circumferential surface thereof comes into contact with the thermal head 30. The platen roller 31 includes a driven gear (not shown) fixed at one end thereof, the driven gear being engaged with a gear transmission mechanism (not shown) rotated by a motor (stepping motor, for example) 40 illustrated in FIG. 1. With this structure, the platen roller 31 is rotated by the rotatably driving force from the motor 40, whereby the recording sheet P1 can be pulled out to the side of the discharge port 27 (downstream side) or drawn back to the side of the entrance port 26 (upstream side). Specifically, the motor 40 is forward-reverse rotatable by receiving the signal of the control section (not shown).

On the downstream side of the platen roller 31 in the conveying direction, the cutting member 32 for cutting the recording sheet P1 which has passed through the thermal head 30 to be subjected to the printing is provided. The cutting member 32 includes a fixed blade 37 provided below the recording sheet P1 to be contactable with a back surface of the recording sheet P1, and a movable blade 38 provided on the side opposite to the fixed blade 37 through the recording sheet P1, which is provided slidable in a direction approximately perpendicular (vertical) to the conveying direction of the recording sheet P1 by a motor (not shown) controlled by the control section.

A second guide member 41 for guiding the recording sheet 21, which has passed through the thermal head 30, to the cutting member 32 is provided between the cutting member 32 and the thermal head 30. The second guide member 41 includes, as in the case of the first guide member 33 described above, a lower guide 42 provided below the recording sheet P1 and an upper guide 43 provided on the side opposite to the lower guide 42 through the recording sheet P1. A path between the guides 42 and 43 is formed as a guide path 44 through which the recording sheet P1 passes. The guide path 44 is configured to have a gradually reducing width in the height direction from the entrance port 26 to the discharge port 27.

A pair of extending walls 25c extending from the rear wall 25a toward the other longitudinal end side (rear side) of the base 15 in a parallel manner are formed on the rear wall 25a of the casing 25 of the print unit 21. In an upper portion of each of the extending walls 25c, an elongated groove 45, which is inclined forward from the bottom to the top, is formed. A tension roller 46 is slidably supported in the elongated groove 45. The tension roller 46 includes supporting portions 47 formed on its both ends to be respectively inserted into the elongated grooves 45, and a roller main body 48 formed between the supporting portions 47, which has a larger outer diameter than that of each of the supporting portions 47.

The roller main body 48 is made of a rubber or the like, has a columnar shape, and has an outer circumferential surface contactable with the recording sheet P1. Then, the recording sheet P1 fed from the roll paper holding mechanism 20 passes below the roller main body 48, and is fed to the entrance port 26 of the print unit 21 after being bent at approximately 90 degrees by the roller main body 48.

On the other hand, in a lower portion of each of the extending walls 25c and on an extension of the elongated groove 45, a pole 49 provided to protrude from an outer surface of each of the extending walls 25c is formed. Between the supporting portion 47 of the tension roller 46 and the pole 49, an elastic member 50 such as a coil spring is interposed. The elastic members 50 bias the tension roller 46 in a direction for bringing the tension roller 46 and the poles 49 closer to each other. As a result, the tension roller 46 is located in lower end portions of the elongated grooves 45 as its initial position.

Then, the tension roller 46 supports the recording sheet P1 in such a manner that the recording sheet P1 is pressed down, specifically, the recording sheet P1 is biased to apply a tension thereto. As a result, the recording sheet P1 is guided to the print unit 21 while being applied with the tension by the tension roller 46 between the roll paper holding mechanism 20 and the print unit 21. The tension roller 46 slides in the elongated grooves 45 in a direction which intersects the conveying direction of the recording sheet P1 according to the tension applied to the recording sheet P1 bridged between the roll paper holding mechanism 20 and the print unit 21. As a result, the tension applied to the recording sheet P1 fed from the roll paper P can be adjusted between the roll paper holding mechanism 20 and the print unit 21.

(Roll Paper Holding Mechanism)

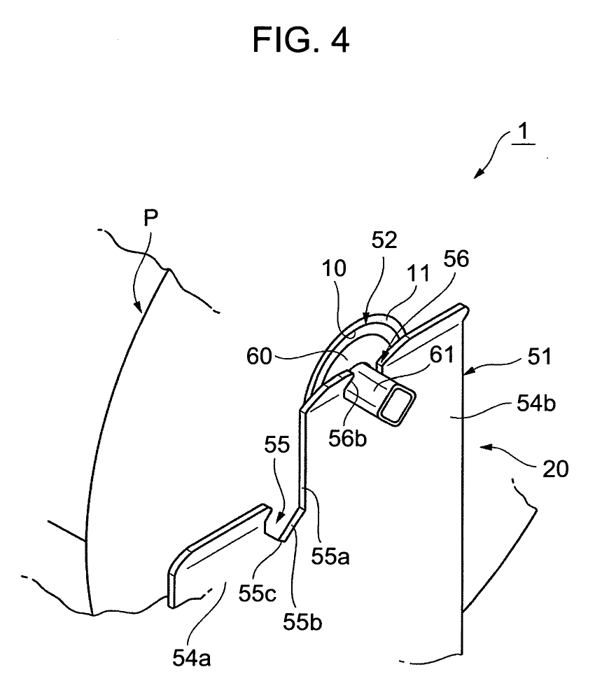

FIG. 4 is an enlarged perspective view of the roll paper holding mechanism.

Here, as illustrated in FIGS. 1, 2 and 4, the roll paper holding mechanism 20 described above includes the holder 51 provided on the upper panel 19 and the shaft 52 supported by the holder 51.

The holder 51 is a C-shaped member when viewed from the side, which includes a lower wall 53 in surface connection with the upper panel 19 and a pair of side walls 54 formed by vertically bending both ends of the lower wall 53 in the width direction to extend in a vertical direction. A space between the pair of side walls 54 forms a housing portion for housing the roll paper P therein.

Each of the side walls 54 includes a front portion 54a formed on the front side (on the side of the print unit 21) in the width direction and a rear portion 54b integrally formed with the front portion 54a on the rear side in the width direction to have a larger height than that of the front portion 54a in the height direction. A tip of each of the front portion 54a and the rear portion 54b is formed to be bent in a direction in which the space between the side walls 54 is enlarged (outward).

In a rear part of the front portion 54a, a first supporting portion 55 for supporting the shaft 52 is formed. The first supporting portion 55 is a groove formed by notching an upper edge of the front portion 54a in the height direction, and includes a vertical portion 55a corresponding to a vertically cut portion on the upper end side of the first supporting portion and a holding portion 55b having a V-shape when viewed from the side, which is formed to have a gradually reduced width of the groove on the lower end side. A width of the vertical portion 55a is formed to be longer than that of a diagonal of a cross section of each of poles 61 of the shaft 52 described below, which is vertical to an axial direction. The holding portion 55b is tapered downward while being inclined at an angle of, for example, about 45 degrees, and is a portion for holding the shaft 52. At a lower end of the holding portion 55b, an intersection point portion 55c, at which edges of the holding portion 55b intersect at an angle of, for example, 90 degrees, is formed. Specifically, the intersection point portion 55c of the first supporting portion 55 corresponds to a single intersection point at the lowermost portion of the first supporting portion 55.

On the other hand, a second supporting portion 56 for supporting the shaft 52 is formed at an intermediate position of each of the rear portions 54b in the width direction. The second supporting portion 56 has the same structure as that of the first supporting portion 55 described above. From an upper end, a vertical portion 56a, a holding portion 56b, and an intersection point portion 56c (see FIG. 2) are formed.

As described above, in the thermal printer 1 according to this embodiment, the two supporting portions 55 and 56 for supporting the shaft 52 are formed for the holder 51. An arbitrary one of the holding portion 55b of the first supporting portion 55 and the holding portion 56b of the second supporting portion 56 is made to support the shaft 52. In this case, the second supporting portion 56 is formed at the position higher than that of the first supporting portion 55 in the height direction. Specifically, the thermal printer 1 can switch between the supporting portions 55 and 56 for holding the roll paper P according to the outer diameter size of the roll paper P. More specifically, it is preferred to perform setting to cause the second supporting portions 56 to support the roll paper P having a relatively large diameter and to cause the first supporting portions 55 to support the roll paper P having a relatively small diameter. The roll paper P used in this embodiment has the outer diameter size of six inches, and hence the roll paper P is supported by the second supporting portions 56.

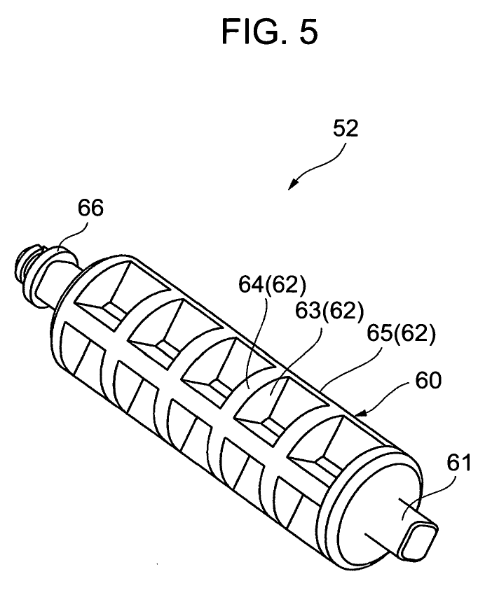

FIG. 5 is a perspective view of the shaft.

As illustrated in FIG. 5, the shaft 52 is placed in the supporting portions (second supporting portions 56 in this embodiment) of the holder 51 in a drop-in manner (by a so-called drop-in method) while being inserted through the roll paper P, and includes a shaft main body 60 inserted into the hollow 10 of the core tube 11 of the roll paper P to support the roll paper P, and a pair of the poles 61 which can be housed within the second supporting portions 56 described above.

The shaft main body 60 has a columnar shape, and has an outer diameter smaller than an inner diameter of the core tube 11 of the roll paper P. Specifically, the hollow 10 of the core tube 11 of the roll paper P and an outer circumferential surface of the shaft main body 60 have a gap therebetween in a state where the shaft main body 60 is inserted through the hollow 10 of the core tube 11 of the roll paper P. As a result, the roll paper P is rotatable with respect to the shaft 52. Edges of both ends of the shaft main body 60 are chamfered to allow the shaft 52 to be smoothly inserted through the roll paper P.

An uneven portion 62 is formed on the outer circumferential surface of the shaft main body 60. The uneven portion 62 includes concave portions 63 formed by hollowing out the outer circumferential surface of the shaft main body 60 inward in the diameter direction in a fan-like fashion, and circumferential convex portions 64 and axial convex portions 65, which form the outer circumferential surface of the shaft 52 between the concave portions 63.

The concave portions 63 are formed at four positions at equal intervals along the circumferential direction of the shaft 52. The concave portions 63 are formed in five rows at equal intervals along the axial direction.

The axial convex portions 65 are rib-like portions, each being formed between the concave portions 63 in the circumferential direction of the shaft 52, and are formed at four positions at equal intervals to be parallel to the axis of the shaft 52 along the circumferential direction thereof. On the other hand, the circumferential convex portions 64 are rib-like portions, each being formed between the concave portions 63 in the axial direction of the shaft 52, and are formed at four positions at equal intervals along the axial direction.

Each of the poles 61 extends from the center of each of both end surfaces of the shaft 52 to the axis direction of the shaft 52, and has chamfered corners at its tip.

The profile of the cross section of the pole 61, which is vertical to the axial direction, is formed to have a square shape. The shaft 52 is supported by the second supporting portions 56 of the holder 51 while the diagonal of the cross section of the pole 61 is aligned with the vertical direction. More specifically, a top of the pole 61 is in conformity to the intersection point portion 56c of the second supporting portion 56, whereas two sides of the pole 61 are supported in a state of abutting against the holding portion 56b of the second supporting portion 56. As described above, the two sides of the pole 61 of the shaft 52 are supported by the holding portion 56b of the second supporting portion 56. Thus, even when a frictional force generated at the time of rotation of the roll paper P acts on the shaft 52, the shaft 52 does not rotate with respect to the holder 51. Specifically, the roll paper P is configured to be rotatable with respect to the shaft 52, whereas the shaft 52 is configured to be unrotatable with respect to the holder 51.

On an outer circumferential surface of one of the poles 61 extending in the opposite axial directions of the shaft 52, a ring portion 66 extending in the diameter direction of the shaft main body 60 is formed. The ring portion 66 is formed to be outside of the side wall 54 when the roll paper P is placed. The side wall 54 is interposed between one end surface of the shaft main body 60 and the ring portion 66. Specifically, the ring portion 66 has a function as a stopper when a force in the axial direction acts on the shaft 52, and abuts against the outer surface of the side wall 54 to restrain the movement of the shaft 52 in the axial direction.

(Action)

Next, the action of the above-mentioned thermal printer is described. In the following description, a method of placing the roll paper P and a method of operating the thermal printer 1 are mainly described.

(Method of Placing the Roll Paper)

Based on FIGS. 1, 2 and 4, the method of placing the roll paper P for placing the roll paper P in the thermal printer 1 is described.

First, the shaft 52 is inserted into the hollow 10 of the core tube 11 of the roll paper P to allow the roll paper P to be held by the shaft 52.

Next, the roll paper P is placed together with the shaft 52 in the second supporting portions 56 with the shaft 52 being inserted through the roll paper P. More specifically, the shaft 52 is placed in the second supporting portions 56 of the holder 51 in a drop-in manner while the roll paper P is adjusted to be positioned between the side walls 54 (in the housing portion) of the holder 51. As a result, the top of each of the poles 61 of the shaft 52 is in conformity to the intersection point portion 56c of each of the second supporting portions 56, whereas two sides of each of the poles 61 abut against the holding portion 56b of each of the second supporting portions 56. In this state, the shaft 52 is placed in the holder 51.

By forming the holding portion 56b on the lower end side of the second supporting portion 56, even if one side of the cross section of the pole 61, which is vertical to the axial direction, abuts against the holding portion 56b while being aligned with the horizontal direction when the shaft 52 is dropped therein, the corners of the pole 61 slip down over the holding portion 56b without getting stuck while slipping due to a load of the roll paper P and the shaft 52. Specifically, by the slip of the corners of the pole 61 over the holding portion 56b, the pole 61 is rotated to allow the corner of the pole 61 to reach the intersection point portion 56c without fail. As a result, it can be ensured that two sides of the pole 61 abut against each of the holding portions 56b, and hence the roll paper P can be easily and surely placed.

By the above-mentioned operation, the placement of the roll paper P is completed.

(Method of Operating the Thermal Printer)

Next, based on FIGS. 1 to 5, the method of operating the thermal printer 1 is described.

First, as an initial state, it is supposed that the roll paper P is placed in the holder 51 by the above-mentioned method of placing the roll paper P. It is also supposed that the recording sheet P1 of the roll paper P is guided from the entrance port 26 to the discharge port 27 of the print unit 21.

First, when a user operates an operating panel (not shown) of an account machine or a ticket-vending machine, the control section of the thermal printer 1 controls each of the components for performing the printing on the recording sheet P1 according to a purpose of the operation, the amount of information to be printed or the like. Specifically, the motor 40 is driven to rotate the platen roller 31, while the heat-generating elements of the thermal head 30 are operated based on the amount of information to be printed. As a result, characters or graphics according to the amount of information are printed on the recording sheet P1 which is then received by the user through the discharge port of the case.

For pulling out the recording sheet P1 from the roll paper P by the rotation of the platen roller 31, the frictional force between the roll paper P and the outer circumferential surface of the shaft 52 is larger when the roll paper P is stationary as compared with the case where the roll paper P is being rotated. Therefore, for the initial operation of the roll paper P, a larger force is required as compared with the case where the roll paper P is being rotated.

When the platen roller 31 starts to be rotated while the roll paper P is in the stationary state, the tension applied to the recording sheet P1 bridged between the roll paper P and the platen roller 31 increases while the roll paper P remains unrotated. Then, when the tension applied to the recording sheet P1 exceeds an elastic force of the elastic members 50 for supporting the tension roller 46, the elastic members 50 extend to allow the tension roller 46 to slide upward in the elongated grooves 45. As a result, the conveyance of the recording sheet P1 is started while the tension roller 46 is moved against the biasing force of the tension roller 46. Thereafter, the roll paper P starts rotating with respect to the shaft 52 along with the inertia force of the recording sheet P1 which has started to be conveyed. As a result, the recording sheet P1 can be pulled out toward the downstream side by the platen roller 31. When the roll paper P starts rotating, the frictional force acting between the roll paper P and the shaft 52 is reduced. Therefore, the tension applied to the recording sheet P1 is also reduced. Thus, the tension applied to the recording sheet P1 becomes smaller than the elastic force of the elastic members 50 which support the tension roller 46. Then, each of the elastic members 50 is gradually reduced in length to allow the tension roller 4 6 to gradually return to its initial position (on the lower end side of the elongated grooves 45).

In this embodiment, each of the poles 61 of the shaft 52 is formed to have a square shape, and two sides of the pole 61 abut against the holding portion 56b of the second supporting portion 56. Therefore, with the rotation of the roll paper P, the shaft 52 does not rotate with respect to the holder 51 even when the force acts on the shaft 52 in the same direction as the rotating direction of the roll paper P.

Then, various characters, graphics and the like are clearly printed on the recording sheet P1 by the heat-generating elements which generate heat when the recording sheet P1 passes under the thermal head 30 while being fed by the platen roller 31 toward the downstream side. The recording sheet P1, on which the printing has been performed, is guided to the discharge port 27 through the guide path 44 of the second guiding member 41 to start to be discharged from the discharge port 27 to the outside (to the discharge port of the case).

Then, the control section outputs a signal to the motor to allow the movable blade 38 to be operated at timing at which the discharge of the printed portion from the discharge port 27 is completed. Upon output of the signal, the movable blade 38 slides along the fixed blade 37 to cut the recording sheet P1. As a result, the recording sheet P1 wound into the roll paper P can be received by the user as a receipt, a ticket or the like.

Thereafter, upon termination of the printing on the recording sheet P1, a driving stop signal is output from the control section to the motor 40 and the thermal head 30. In response to the driving stop signal, the driving of the motor 40 and the thermal head 30 is stopped. As a result, the rotation of the platen roller 31 is stopped, whereas the heat generation of the heat-generating elements is stopped.

Immediately after the stop of the rotation of the platen roller 31, the roll paper P tends to automatically continues rotating due to inertia acting on the roll paper P. Therefore, there is a problem that the recording sheet P1 is loosened between the platen roller 31 and the holder 51.

In the thermal printer 1 of this embodiment, the uneven portion 62 is formed on the shaft 52. Therefore, during the rotation of the roll paper P with respect to the shaft 52, when a contact portion of the inner circumferential surface of the core tube 11 with the shaft 52 passes from the concave portion 63 of the shaft 52 through the axial convex portion 65 or from the axial convex portion 65 through the concave portion 63, the axial convex portion 65 and the inner circumferential surface of the core tube 11 rub against each other to attenuate the turning force of the roll paper P due to the frictional force.

In addition, the shaft 52 is configured to be unrotatable with respect to the holder 51 as described above, whereby a force acting against the rotating direction of the roll paper P is generated between the shaft 52 and the holder 51. Specifically, the stop of rotation of the platen roller 31 attenuates the turning force of the roll paper P.

As described above, in this embodiment, the structure is employed in which the roll paper P is supported rotatably with respect to the shaft 52 while the shaft 52 is supported unrotatably with respect to the holder 51.

According to this structure, at the time of the operation of the thermal printer 1, the recording sheet P1 is pulled by the rotation of the platen roller 31 to apply the tension to the recording sheet P1. Therefore, the roll paper P rotates with respect to the shaft 52. As a result, the recording sheet P1 is fed to the print unit 21.

At the time of feeding, with the provision of the tension roller 46 between the roll paper holding mechanism 20 and the print unit 21, the tension applied to the recording sheet P1 can be adjusted between the roll paper holding mechanism 20 and the print unit 21. Specifically, at the time of the initial operation of the roll paper P, the tension roller 46 slides according to the tension applied to the recording sheet P1. As a result, the conveyance of the recording sheet P1 is started while the tension roller 46 is being moved against the biasing force of the tension roller 46. Thereafter, the roll paper P starts rotating with respect to the shaft 52 along with the inertia force of the recording sheet P1 which has started to be conveyed. Therefore, as compared with the case where the roll paper P is rotated simultaneously with the start of the conveyance of the recording sheet P1, the roll paper P can be easily rotated. As a result, the recording sheet P1 can be smoothly guided to the print unit 21. Thus, the initial operation of the roll paper P can be smoothly performed without increasing the size of the motor 40, and hence the manufacturing cost can be reduced while the apparatus size can be reduced.

On the other hand, the shaft is configured to be unrotatable with respect to the holder 51, and hence the force acts between the shaft 52 and the holder 51 in the direction against the rotating direction of the roll paper P immediately after the operation of the thermal printer 1 is stopped. In this case, the force acting against the rotating direction of the roll paper P becomes greater as compared with the case where the shaft 52 and the roll-paper P rotate in cooperation. Therefore, the turning force of the roll paper P can be actively attenuated. In addition, the uneven portion 62 is formed on the shaft 52. Thus, when the contact portion of the inner circumferential surface of the core tube 11 with the shaft 52 passes from the concave portion 63 of the shaft 52 through the axial convex portion 65 or from the axial convex portion 65 through the concave portion 63 at the time of rotation of the roll paper P with respect to the shaft 52, the turning force of the roll paper P can be efficiently attenuated by the frictional force between the axial convex portion 65 and the inner circumferential surface of the core tube 11.

As a result, after the stop of the rotation of the platen roller 31, the roll paper P also quickly stops rotating. Thus, the recording sheet P1 can be prevented from being loosened between the platen roller 31 and the holder 51 to prevent inconvenience such as the misalignment of the recording sheet P1 fed to the thermal head 30 with respect to the conveying direction. In particular, in comparison with the structure of bringing the rotation restraining portion into contact with the outer circumferential surface of the roll paper as in the conventional cases, the rotation of the roll paper P can be stopped without damaging the roll paper P. Therefore, the printing precision can be prevented from being lowered to perform the printing with high precision.

In addition, each of the poles 61 of the shaft 52 is formed in the square shape, whereas the holding portion 56b of the second supporting portion 56 is formed in the V-shape. Therefore, when the roll paper P is placed, the holding portion 56b and two sides of the pole 61 are held in an abutting state. As a result, the prevention of the rotation of the shaft 52 is ensured.

Then, each of the poles 61 is held in the holding portion 56b to allow the diagonal of the cross section of the pole 61 of the shaft 52 to be aligned with the vertical direction. As a result, even if the shaft 52 abuts against the holding portion 56b in the state where the diagonal of the cross section of the pole 61 is aligned with the horizontal direction when the shaft 52 is placed in the holder 51, the corners of the pole 61 slip over the holding portion 56b without getting stuck while slipping due to the load of the roll paper P and the shaft 52. As a result, it is ensured that two sides of the pole 61 can abut against the holding portion 56b, and hence the roll paper P can be easily and surely placed.

In the case of the structure of, for example, supporting the shaft 52 while one side of the pole 61 is aligned with the horizontal direction, specifically, in the case where the width of the holding portion 56b is formed to be larger than a length of one side of the pole 61 and smaller than a length of the diagonal of the cross section, there is a fear that the pole 61 cannot be successfully placed in the holding portion 56b but gets stuck before the successful placement in a state where the diagonal of the cross section of the pole 61 is aligned with the vertical direction. Therefore, for placing the shaft 52 in the holding portion 56 without fail, it is necessary to place each of the poles 61 with one side of the pole 61 being aligned with the horizontal direction, thereby complicating the operation of placing the roll paper P.

On the other hand, the width of the holding portion 56b in this embodiment is formed to be larger than the length of the diagonal of the cross section of the pole 61, whereas the structure is employed in which the top of the pole 61 and the intersection point portion 56c of the second supporting portion 56 are in conformity to each other. Therefore, even when the shaft 52 is placed in a drop-in manner, the corners of the pole 61 do not get stuck before the successful placement. Therefore, the corner of the pole 61 reaches the intersection point portion 56c without fail. As a result, the roll paper P can be easily and surely placed.

The technical scope of the present invention is not limited to the embodiment described above, and various changes are possible without departing from the spirit of the present invention.

For example, the case where the roll paper P having the outer diameter size of six inches has been described in the above-mentioned embodiment, but the outer diameter size of the roll paper is not limited thereto. The roll paper P of various outer diameter sizes can be used. Moreover, when the roll paper P having the outer diameter size of six inches is used as in the case of this embodiment, the roll paper P is placed in the second supporting portions 56 of the holder 51. However, when the roll paper P having a relatively small outer diameter size is used, it is preferred to place the roll paper P in the first supporting portions 55. The method of placing the roll paper P and the method of operating the thermal printer 1 in this case are the same as those described above.

Further, the description has been made using the roll paper formed by winding the recording sheet around the core tube in this embodiment, but the roll paper is not required to include the core tube as long as the roll paper has the hollow therein for axially supporting the roll paper.

Further, the shape of the uneven portion formed on the shaft can be appropriately changed in design as long as the contact portion between the outer circumferential surface of the shaft and the core tube of the roll paper is reduced. For example, in this embodiment, the case where the plurality of concave portions 63 are formed by hollowing out the outer circumferential surface of the shaft 52 while the convex portions 64 and 65 constituting the outer circumferential surface of the shaft 52 are formed between the concave portions 63 has been described. However, the structure may be employed in which the convex portions are formed to protrude from the outer circumferential surface of the shaft.

Moreover, the profile of the cross section of the pole, which is vertical to the axial direction, is not limited to the square, and can be appropriately changed in design to be, for example, a triangle.

What is claimed is:

1. A thermal printer, comprising:
a roll paper holding mechanism for holding roll paper formed by winding a recording sheet to have a hollow therein;
a thermal head including a large number of heat-generating elements arranged along a width direction of the recording sheet; and
a platen roller for making a rotation while pinching the recording sheet against the thermal head to feed the recording sheet,
the thermal printer performing printing on the recording sheet pulled out from the roll paper with the thermal head, wherein:
the roll paper holding mechanism includes:
a shaft inserted through the hollow to support the roll paper; and
a holder including supporting portions for supporting both end portions of the shaft; and
the roll paper is supported rotatably with respect to the shaft, whereas the shaft is supported unrotatably with respect to the holder.

2. A thermal printer according to claim 1, wherein an uneven
portion is formed on an outer circumferential surface of the shaft.

3. A thermal printer according to claim 1, wherein a tension
roller for biasing the recording sheet to apply a tension to the
recording sheet is provided between the roll paper holding mechanism and the platen roller in a conveying direction of the recording sheet.

4. A thermal printer according to claim 1, wherein each of the both end portions of the shaft is formed to have an approximately square profile on a cross section vertical to an axial direction of the shaft.

5. A thermal printer according to claim 4, wherein:
each of the supporting portions is formed to have a V-groove shape to support at least two sides of each of the both end portions of the shaft; and
the both end portions of the shaft are supported by the supporting portions to allow a diagonal of the cross section vertical to the axial direction to be aligned with a vertical direction.
